(19) United States
(12) Patent Application Publication
(10) Pub. No.: US 2013/0076785 A1
(43) Pub. Date: Mar. 28, 2013

(54) ANTI-PEEPING DISPLAY SYSTEM

(71) Applicant: Chien-hung CHEN, New Taipei City (TW)

(72) Inventor: Chien-hung CHEN, New Taipei City (TW)

(73) Assignee: CHUNGHWA PICTURE TUBES, LTD., Bade City (TW)

(21) Appl. No.: 13/402,910

(22) Filed: Feb. 23, 2012

(30) Foreign Application Priority Data
Sep. 27, 2011 (TW) 100134816

(51) Int. Cl. G09G 5/00

(52) U.S. Cl. 345/629

(57) ABSTRACT

An anti-peeping display system comprises an image processor for receiving a normal image and generating a mosaic image according to the normal image; and a display module which is coupled to the image processor for receiving the normal image and the mosaic image, the display module displaying the normal image during a first frame period and displaying the mosaic image during a second frame period that is adjacent to the first frame period. A user only by wearing a pair of special glasses can view the normal images. The present invention can make a display device to equip with an anti-peeping function.

### TECHNICAL FIELD OF THE INVENTION

The present invention relates to a display system, and more particularly, to a display system capable of implementing an anti-peeping function.

### BACKGROUND OF THE INVENTION

Display devices have become indispensable products in our lives. The display devices currently are developing consistently into having high quality and high resolution, as well as developing to have many extra functions, such as a touch-sensitive function achieved by combining with a touch panel, a dual-view (or multi-view) function provided for different users to view at the same time, and a stereoscopic display function. However, when a user uses a display device, especially a portable display device, the user often does not want another person to see the content being displayed. Traditional display devices lack an anti-peeping function meeting a demand for information privacy and security. Therefore, developing a display device to have the anti-peeping function is gradually becoming an important issue in this field.

### SUMMARY OF THE INVENTION

An objective of the present invention is to provide an anti-peeping display system to implement an anti-peeping display function and keep information private and secure.

To achieve the above objective, the present invention provides an anti-peeping display system, which comprises an image processor for receiving a normal image and for generating a mosaic image according to the normal image; and a display module which is coupled to the image processor for receiving the normal image and the mosaic image, the display module displaying the normal image during a first frame period and display the mosaic image during a second frame period that is adjacent to the first frame period.

In one embodiment, the anti-peeping display system further comprises a pair of shutter glasses having two pieces of eyeglasses. The two eyeglasses are adjusted into a transparent state during the first frame period, and are adjusted into a masking state during the second frame period.

In another embodiment, the anti-peeping display system further comprises a dynamic polarizing panel and a pair of polarized glasses. The dynamic polarizing panel is coupled to the display module and is utilized for transforming the normal image to have a first polarizing direction during the first frame period and transforming the mosaic image to have a second polarizing direction during the second frame period. The polarized glasses have a left eyeglass and a right eyeglass of which axes of transmission are the same as the first polarizing direction for viewing the normal image.

The present invention presents the normal images and the mosaic images alternatively on a screen by displaying the normal images during the first frame period and displaying the mosaic images during the second frame period. In this manner, a user can view the normal images only when wearing special glasses. A user who is not wearing the special glasses will be interfered by the mosaic images being presented on the screen and can not clearly recognize the image content. Therefore, the present invention can make a display device to equip with an anti-peeping function.

### BRIEF DESCRIPTION OF THE DRAWINGS

FIG. 1 is a flow chart showing an anti-peeping displaying method of the present invention.

FIG. 2 is a schematic diagram showing sequentially displayed normal images and mosaic images in the present invention.

FIG. 3 is a flow chart showing a step of generating a mosaic image according to a normal image in the anti-peeping displaying method of the present invention.

FIG. 4 is a schematic diagram showing an anti-peeping display system implemented according to a first embodiment of the present invention.

FIG. 5 is a schematic diagram showing an anti-peeping display system implemented according to a second embodiment of the present invention.

FIG. 6 is a schematic diagram showing a display device assembled by a display module and a dynamic polarizing panel in the second embodiment of the present invention.

FIG. 7 is a timing diagram of the anti-peeping display system shown in FIG. 5 and FIG. 6.

### DETAILED DESCRIPTION OF THE INVENTION

The anti-peeping display system of the present invention is applicable to liquid crystal displays, organic light emitted diode displays, plasma display panels, and etc. In brief, when playing a film clip or displaying images on a screen of a display device, the present invention displays normal images and mosaic images alternatively on the screen such that a user can view the normal images only when the user puts on a pair of special glasses, and a user who is not wearing the special glasses can not recognize the image content presented on the screen; therefore, the present invention can implement an anti-peeping display function and keep information private and secure.

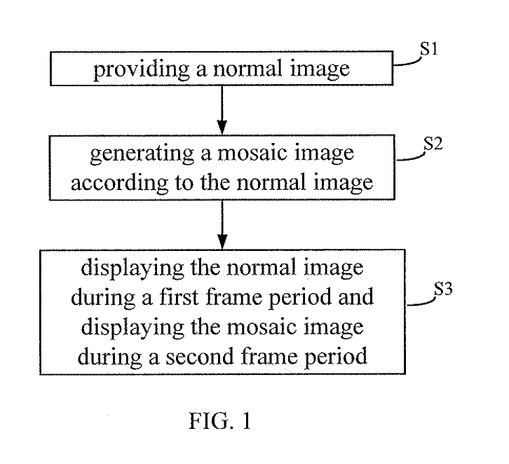

FIG. 1 is a flow chart showing an anti-peeping displaying method of the present invention. The anti-peeping displaying method is utilized for displaying a sequence of images including the normal images and the mosaic images. Since the present invention displays each set of a normal image and a mosaic image in the same manner, the following sections are merely descriptions for one set thereof. At first, an image or a normal image is provided (Step S1). The normal image is an image to be displayed on a screen. Next, a mosaic image is generated according to the normal image (Step S2). The mosaic image is generated by processing the normal image, and this step will be described more concretely later. Then, the normal image and the mosaic image are provided for a display device. The display device displays the normal image and the mosaic image sequentially on the screen. That is to say, the display device displays the normal image during a first frame period and displays the mosaic image during a second frame period. The first frame period and the second frame period are adjacent to each other (Step S3).

It is noted that the present invention also can process a plurality of normal images, generate corresponding mosaic images respectively according to each of the normal images, and then provide these normal images and the generated mosaic images for the display device to be displayed on the screen thereof.

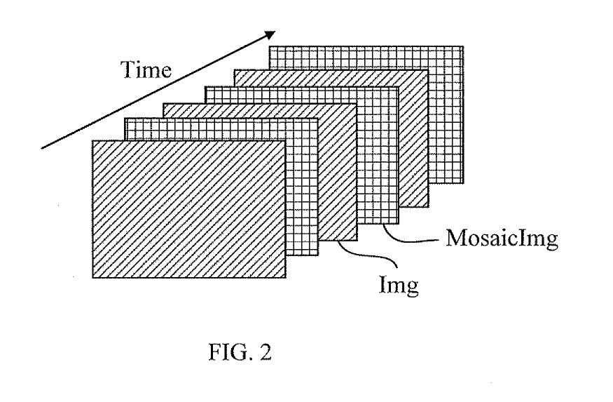

Furthermore, these normal images and mosaic images are alternatively displayed in the displaying processes. A normal image can be displayed before or after a corresponding mosaic image. One mosaic image is interpolated between two normal images, as shown in FIG. 2. In one embodiment, the display device provides image data at a frequency of 120 Hz. The frequency to display the normal images is 60 Hz and the frequency to display the mosaic images is also 60 Hz.

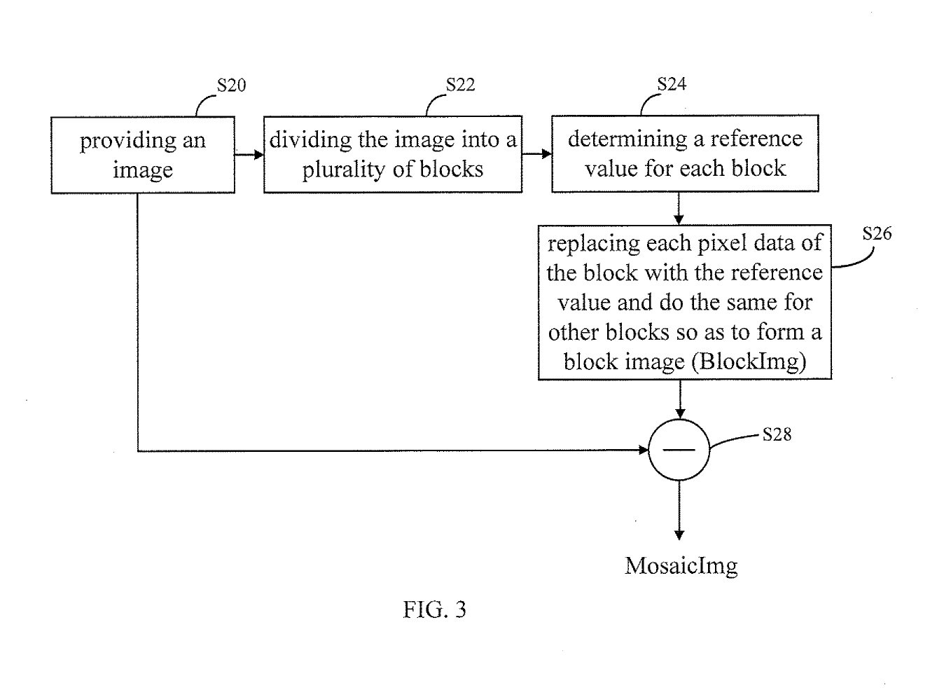

FIG. 3 is a flow chart showing a step of generating a mosaic image according to a normal image in the anti-peeping displaying method of the present invention. In the present invention, the generation of the mosaic image can include sub-steps as below.

Step S20: An image (Img) or a normal image is received.

Step S22: The normal image is divided into a plurality of blocks. For example, the normal image is divided into a×b blocks. Each block is represented by block(i,j), where i=1 to a, j=1 to b, and a, b are integers.

Step S24: Seek out pixel data for each pixel in each block. A reference value of the block is determined according thereto. For example, seek out the maximum pixel data in one block to serve as the reference value and do the same for each block(i, j). For example, seek out the maximum data of red sub-pixels R_{MAX}(i, j), the maximum data of green sub-pixels G_{MAX}(i, j), and the maximum data of blue sub-pixels B_{MAX}(i, j) in one block and do the same for each block(i, j).

Step S26: The reference value replaces the pixel data of each pixel in the block and this is processed for each block so as to form a block image. It is assumed that there are c×d pixels in each one block(i, j), the pixel data of each pixel in the block is represented by P(x, y), where x=1 to c, y=1 to d, and c, d are integers. In this step, the pixel data of each pixel in the block P(x, y) is all replaced by R_{MAX}(i, j), G_{MAX}(i, j), and B_{MAX}(i, j). That is, P(x, y)=(R_{MAX}(i, j), G_{MAX}(i, j), B_{MAX}(i, j)). Each block will respectively form a new block after processed by afore-mentioned replacing operations. These new blocks are combined at their original positions to form an image, which is called a block image (BlockImg) herein.

Step S28: A mosaic image (MosaicImg) is established based on differences or difference values between the normal image (Img) and the block image (BlockImg). For example, perform an image subtraction of the normal image and the block image. That is, calculate an absolute value of the difference between the pixel data of corresponding pixels and do the same for other pixels in the normal image and the block image for establishing the mosaic image.

In Step S24, the reference value is an extreme value of each pixel data in the block. It also can adopt a minimum pixel data of the block for serving as the reference value, except for the maximum pixel data of the block, to proceed with the replacing operations in Step S26. In addition, in another embodiment, a median value or an average value of each pixel data in the block is adopted for serving as the reference value to proceed with the replacing operations in Step 26.

Above all, the present invention presents the normal images and the mosaic images alternatively on the screen by displaying the normal images during the first frame period and displaying the mosaic images during the second frame period. A user who is not wearing special glasses will be interfered by the mosaic images and can not clearly recognize the image content which is presented on the screen. Therefore, the present invention can make the display device equip with an anti-peeping function.

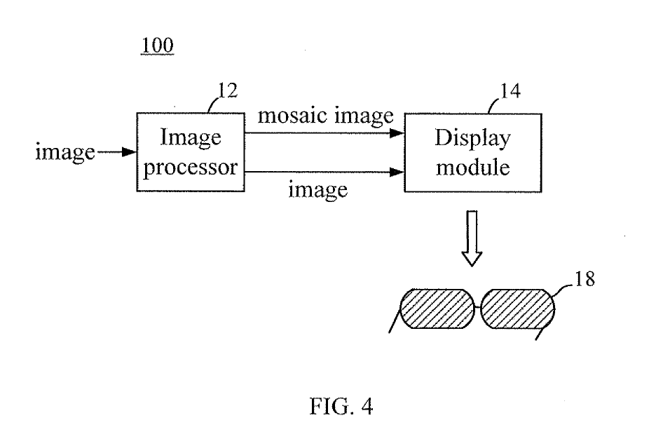

FIG. 4 is a schematic diagram showing an anti-peeping display system implemented according to a first embodiment of the present invention. The anti-peeping display system 100 of the first embodiment of the present invention comprises an image processor 12 and a display module 14. The image processor 12 receives an image such as a normal image, and generates a mosaic image according to the normal image. The image processor 12 can process the normal image to generate the mosaic image based on the afore-mentioned Steps S20 to S28. The display module 14 is coupled to the image processor 12. The display module 14 receives the normal image and the mosaic image from the image processor 12. The display module 14 also can directly receive the normal image rather than receive via the image processor 12. The display module 14 is utilized for displaying the normal image and the mosaic image sequentially. That is, the display module 14 displays the normal image during a first frame period and displays the mosaic image during a second frame period that is adjacent to the first frame period. In addition, the image processor 12 can generate plural mosaic images correspondingly after processing plural normal images, and then transmit these normal images along with the mosaic images to the display module 14. Furthermore, the display module 14 displays the normal images and the mosaic images alternatively on a screen in displaying processes, as shown in FIG. 2.

The anti-peeping display system 100 of the first embodiment of the present invention further comprises a pair of shutter glasses 18 which has two pieces of eyeglasses. The two eyeglasses are turned on (i.e., in a transparent state allowing light rays to penetrate thereto) or turned off (i.e., in a masking state blocking light rays) at the same time. The two eyeglasses of the shutter glasses 18 have a state switching frequency that is the same as an image displaying frequency of the display module 14. The two eyeglasses will be adjusted into the transparent state during the display module 14 displaying the first frame period, and adjusted into the masking state during the display module 14 displaying the second frame period. Therefore, when a user puts on the shutter glasses 18, the user will only view the normal images. The mosaic images will be blocked so as not be transmitted into the user's eyes. In addition, a user who is not wearing the shutter glasses 18 can not recognize the image content presented by the display module 14 since the normal images will be interfered by the mosaic images.

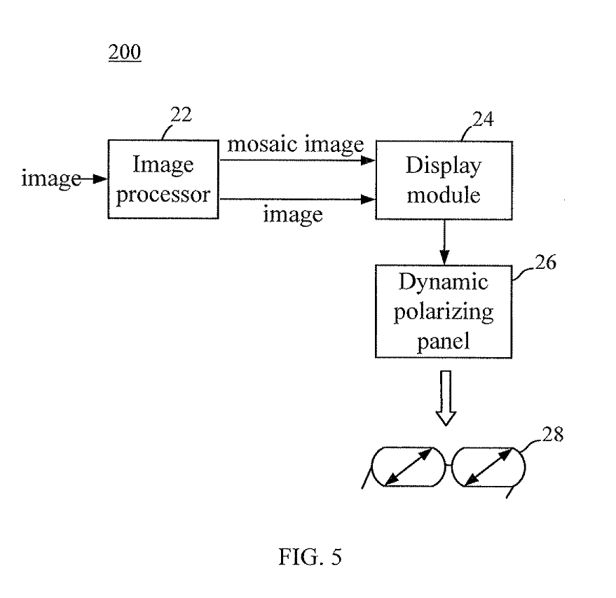

FIG. 5 is a schematic diagram showing an anti-peeping display system implemented according to a second embodiment of the present invention. The anti-peeping display system 200 of the second embodiment of the present invention comprises an image processor 22, a display module 24, a dynamic polarizing panel 26, and a pair of polarized glasses 28. The operations and functions of the image processor 22 and the display module 24 in the second embodiment are similar to those of the image processor 12 and the display module 14 in the first embodiment, and therefore the related descriptions will be omitted herein.

The dynamic polarizing panel 26 of the anti-peeping display system 200 of the present invention is coupled to the display module 24. The dynamic polarizing panel 26 is utilized for making the normal images and the mosaic images from the display module 24 to have different polarizing directions. The dynamic polarizing panel 26 transforms the normal images to have a first polarizing direction during the display module 24 displays in the first frame period, and transforms the mosaic images to have a second polarizing direction during the display module 24 displays in the second frame period. In one embodiment, the dynamic polarizing panel 26 is disposed in the front of the display module 24 and located between the polarized glasses 28 and the display module 24.

The polarized glasses 28 has a left eyeglass and a right eyeglass that are polarized sheets. Transmission axes of the left eyeglass and the right eyeglass are both the same as the afore-mentioned first polarizing direction. The polarized glasses 28 only allow light rays polarized in the first polarizing direction to pass through. Light rays polarized in other directions will be blocked and can not pass through the polarized glasses 28. Therefore, when a user wears the polarized glasses 28, the user can clearly view the normal images polarized in the first polarizing direction and can not view the mosaic images polarized in the second polarizing direction. In addition, a user who is not wearing the polarized glasses 28 can not recognize the image content presented by the display module 24 since the normal images will be interfered by the mosaic images.

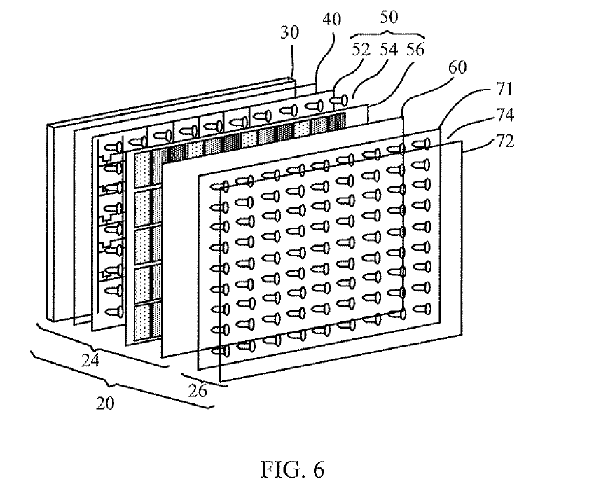

FIG. 6 is a schematic diagram showing a display device assembled by the display module and the dynamic polarizing panel in the second embodiment of the present invention. In the second embodiment of the present invention, the dynamic polarizing panel 26 can be assembled with the display module 24 together to form a display device 20. The implement of the display device 20 is described below.

As shown in FIG. 6, the display module 24 comprises a backlight plate 30, a bottom polarizing film 40, a display panel 50, and a top polarizing film 60. The display panel 50 can be a liquid crystal panel, which includes a thin-film transistor array substrate 52, a color filter substrate 56, and a liquid crystal layer 54 disposed between the two substrates 52, 56. The backlight plate 30 provides at least a back light source, such as a cold cathode fluorescent lamp and light emitting diodes (LEDs). The bottom polarizing film 40 and the top polarizing film 60 are utilized to polarize light rays. The light rays provided by the backlight plate 30 will be polarized by the bottom polarizing film 40. Transistors on the thin-film transistor array substrate 52 can control liquid crystal molecules in the liquid crystal layer 54 to be twisted or not, and thus polarizing angles of the light rays are changed. The light rays polarized in different polarizing directions enter the top polarizing film 60 via the color filter substrate 56. The top polarizing film 60 only allows passing the light rays polarized in a direction that is the same as the transmission axis of the top polarizing film 60, and therefore images displayed by the display module 24 are polarized in a certain direction.

As shown in FIG. 6, the dynamic polarizing panel 26 is disposed in the front of the display module 24. The dynamic polarizing panel 26 can be a liquid crystal panel such as an electrically controlled birefringence (ECB) liquid crystal panel, which comprises a liquid crystal layer 74 disposed between a first glass substrate 71 and a second glass substrate 72. The dynamic polarizing panel 26 can change a polarizing direction of the images from the display module 24 by twisting an arrangement of the liquid crystal molecules in the liquid crystal layer 74. Therefore, the dynamic polarizing panel 26 can transform the normal images coming from the display module 24 to have the first polarizing direction during the first frame period, and transform the mosaic images coming from the display module 24 to have the second polarizing direction during the second frame period.

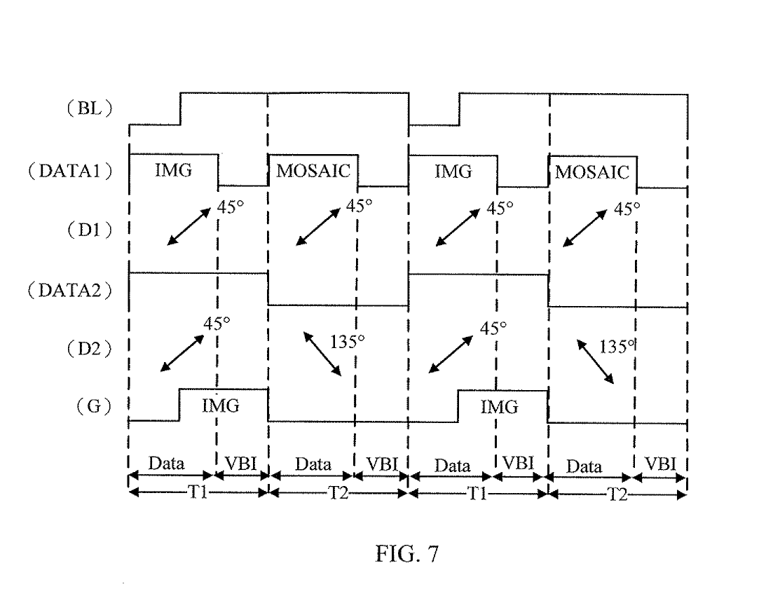

FIG. 7 is a timing diagram of the anti-peeping display system 200 shown in FIG. 5 and FIG. 6. Firstly, the backlight plate 30 provides a back light (BL) source. The emitted light rays go through the bottom polarizing film 40 of which the transmission axis is 135° so as to be polarized in a direction of 135°. The display panel 50 provides image data (DATA1) at a frequency of 120 Hz. By a time division approach, the display panel 50 provides the image data of the normal images and mosaic images generated according to the normal images. As shown in FIG. 7, the image data of the normal images (IMG) are provided during the first frame period (T1) and the image data of the mosaic images (MOSAIC) are provided during the second frame period. The image data of the normal images and the mosaic images are provided sequentially.

Next, the light rays coming from the color filter substrate 56 of the display panel 50 will enter the top polarizing film 60. The transmission axis of the top polarizing film is in a direction of 45°. Therefore, after passing through the top polarizing film 60, the normal images (IMG) and the mosaic images (MOSAIC) are polarized in a direction of 45° (D1). Correspondingly, during the first frame period (T1) and the second frame period (T2), the dynamic polarizing panel 26 respectively provides grey-level signals with level values of 0 and 255 (DATA2) to control the twist of inner liquid crystal molecules (D2) such that the dynamic polarizing panel 26 can allow the normal images (IMG) polarized in a direction of 45° to pass through during the first frame period (T1), and transform the mosaic images (MOSAIC) to have a polarizing direction of 135° during the second frame period (T2).

When a user puts on the polarized glasses 28 having the left eyeglass and the right eyeglass of which axes of transmission are 45°, the user can view the normal images (IMG) and can not view the mosaic images (MOSAIC) (G) polarized in a direction of 135° since the polarized glasses 28 only allows light rays polarized in a direction of 45° to pass through. A user who is not wearing the polarized glasses 28 can not recognize image content presented by the display module 24.

In addition, in the embodiment of implementing the display panel 50 and the dynamic polarizing panel 26 as liquid crystal panels, the liquid crystal molecules located at corresponding positions in the two panels have a problem of possessing different response time. This is easily to cause the normal images and the mosaic images overlapped in displaying processes. The present invention can utilize a dynamic backlight approach to turn off a back light of the display module for a predetermined period of time at the beginning of the first frame period (T1) or at the time the display panel 50 starts to provide the normal images. In this manner, when the normal images and the mosaic images are overlapped, a user wearing the polarized glasses 28 will not view the overlapped images since the back light is turned off at that time. Therefore, the present invention solves the problem of overlapped images.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. An anti-peeping display system comprising:
an image processor for receiving a normal image and for generating a mosaic image according to the normal image; and
a display module which is coupled to the image processor for receiving the normal image and the mosaic image, the display module displaying the normal image during a first frame period and displaying the mosaic image during a second frame period that is adjacent to the first frame period.

2. The anti-peeping display system according to claim 1, wherein the normal image and the mosaic image are sequentially displayed on a screen.

3. The anti-peeping display system according to claim 1, further comprising:
a pair of shutter glasses having two pieces of eyeglasses, the two eyeglasses being adjusted into a transparent state during the first frame period and adjusted into a masking state during the second frame period.

4. The anti-peeping display system according to claim 3, wherein the two eyeglasses of the shutter glasses have a state switching frequency that is the same as an image displaying frequency of the display module.

5. The anti-peeping display system according to claim 1, further comprising:
a dynamic polarizing panel coupled to the display module, for transforming the normal image to have a first polarizing direction during the first frame period and transforming the mosaic image to have a second polarizing direction during the second frame period; and
a pair of polarized glasses having a left eyeglass and a right eyeglass of which axes of transmission are both the same as the first polarizing direction, for viewing the normal image.

6. The anti-peeping display system according to claim 5, wherein the left eyeglass and the right eyeglass of the polarized glasses only allow an image polarized in the first polarizing direction to pass through.

7. The anti-peeping display system according to claim 5, wherein the dynamic polarizing panel is disposed in the front of the display module and located between the polarized glasses and the display module.

8. The anti-peeping display system according to claim 5, wherein the dynamic polarizing panel is a liquid crystal panel.

9. The anti-peeping display system according to claim 5, wherein the dynamic polarizing panel and the display module are assembled together to form a display device.

10. The anti-peeping display system according to claim 5, wherein the display module utilizes a dynamic back light, and the dynamic back light is turned off for a predetermined period of time at the beginning of the first frame period.
